(19) United States
(12) Patent Application Publication
(10) Pub. No.: US 2015/0007096 A1
(43) Pub. Date: Jan. 1, 2015

(54) ROTATION OF GRAPHICAL SCENES

(71) Applicant: Silicon Graphics International Corp., Milpitas, CA (US)

(72) Inventor: Marc David Hansen, Morgan Hill, CA (US)

(73) Assignee: Silicon Graphics International Corp., Milpitas, CA (US)

(21) Appl. No.: 14/042,723

(22) Filed: Oct. 1, 2013

Related U.S. Application Data
(60) Provisional application No. 61/841,259, filed on Jun. 28, 2013.

(51) Int. Cl. G06F 3/0481; G06F 3/0484; G06F 3/0482

(52) U.S. Cl. CPC G06F 3/04815; G06F 3/0482; G06F 3/04845; G06F 3/0484
USPC 715/781; 715/848; 715/840

(57) ABSTRACT

Data visualization is provided with the capability to interactively rotate data about a particular co-ordinate axis or other axis. Data to be visualized is accessed by a data visualization application. The accessed data may be displayed through an interface of the visualization application for a user. A user may rotate data about a particular axis of the coordinate system by providing a continuous input within a graphics portion of an interface. The input may be associated with the particular axis. The data displayed in the interface will rotate about the coordinate axis as the user drags the cursor.

### CROSS-REFERENCE TO RELATED APPLICATIONS

This application claims the priority benefit of U.S. provisional application No. 61/841,259, titled “Rotation of Graphical Scenes,” filed Jun. 28, 2013, the disclosure of which is incorporated herein by reference.

### BACKGROUND

1. Field of the Invention

The present invention relates to visualization of data. In particular, the present invention relates to rotating about graph axes.

2. Description of the Prior Art

Visualization of data in three dimensional graphs can be helpful to understand the data. An example of a three dimensional graph is a plot of data on multiple axis, such as a horizontal, vertical, and another coming towards or away from the point of view of a viewer. Typically, visualization applications which display three dimensional data provide an interface having a graphical portion which provides data graphics and a control portion, such as a bar of control buttons. The control buttons may be implemented on a separate page from the graphical portion or otherwise separated from the graphical portion.

Many users desire to view their data from different angles in order to better understand data being visualized. However, it can be cumbersome to control the display of data from control portions of a visualization interface that are separate from a graphics portion. What is needed is an improved visualization interface for displaying data as desired by a user.

### SUMMARY

The present technology may provide data visualization with the capability to interactively rotate data about a particular co-ordinate axis or other axis. Data to be visualized is accessed by a data visualization application. The data may be structured, semi-structured or unstructured, filtered and analyzed. The accessed data may be displayed through an interface of the visualization application for a user. The coordinate system for displaying the data may also be displayed. A user may rotate data about a particular axis of the coordinate system by providing a continuous input within a graphics portion of an interface. The input may be associated with the particular axis. For example, to rotate data about a particular coordinate axis such as an x, y or z axis displayed in the interface, a user may drag a cursor across the axis within the graphical portion of the interface. The data displayed in the interface will rotate about the coordinate axis as the user drags the cursor.

An embodiment may perform a method for displaying data. A three dimensional image of a set of data and one or more axes may be provided within a graphical portion of an interface. A continuous selection associated with an axis may be received. The continuous selection may be received within the graphical portion of the interface. The image of the analyzed data may be modified based on the selection.

An embodiment may include a system for displaying data. The system may include a processor, a memory, and one or more modules stored in memory. The one or more modules may be executed by the processor to provide a three dimensional image of a set of data and one or more axes within a graphical portion of an interface, receive a continuous selection associated with an axis within the graphical portion of the interface, and modify the image of the analyzed data based on the selection.

### BRIEF DESCRIPTION OF THE DRAWINGS

FIG. 1 is a system for processing and visualizing data.

FIG. 2 is a method for processing and visualization data.

FIG. 3 is a method for providing a data visualization.

FIG. 4 is a visualization interface having a control bar.

FIG. 5 is another example of a visualization interface.

FIG. 6 is a visualization interface having data rotated about an axis.

FIG. 7 is another visualization interface having a control bar.

FIG. 8 is another example of a visualization interface.

FIG. 9 is another visualization interface having data rotated about a display axis.

FIG. 10 provides a computing device for implementing the present technology.

### DETAILED DESCRIPTION

The present technology may provide data visualization with the capability to interactively rotate data about a particular co-ordinate axis or other axis. Data to be visualized is accessed by a data visualization application. The data may be structured or unstructured, filtered and analyzed. The accessed data may be displayed through an interface of the visualization application for a user. The coordinate system for displaying the data may also be displayed. A user may rotate data about a particular axis of the coordinate system by providing a continuous input within a graphics portion of an interface. The input may be associated with the particular axis. For example, to rotate data about a particular coordinate axis such as an x, y or z axis displayed in the interface, a user may drag a cursor across the axis within the graphical portion of the interface. The data displayed in the interface will rotate about the coordinate axis as the user drags the cursor.

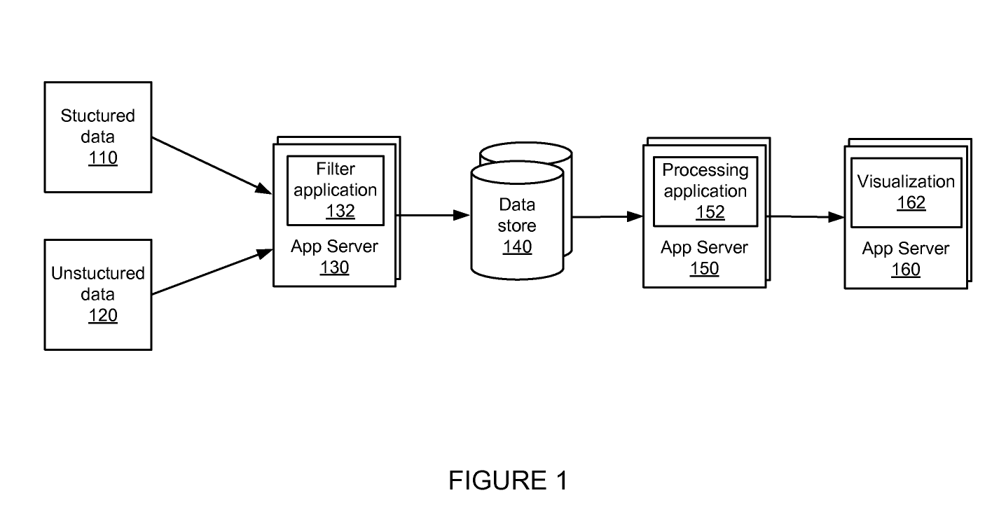

FIG. 1 is a system for processing and visualizing data. The system of FIG. 1 includes structured data 110, unstructured data 120, application servers 130, 150 and 160, and data store 140.

Structured data 110 (RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server may include one or more servers which receive and access structured data 110 and unstructured data 120. Filter application 132 may be stored and executed on application server 130, and may be executed to ingest and the structured and unstructured data. Filter application 132 may apply filters, intelligence, or other processes to select a subset of the data received and/or accessed.

Data store 140 may include one or more data stores which receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application which provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

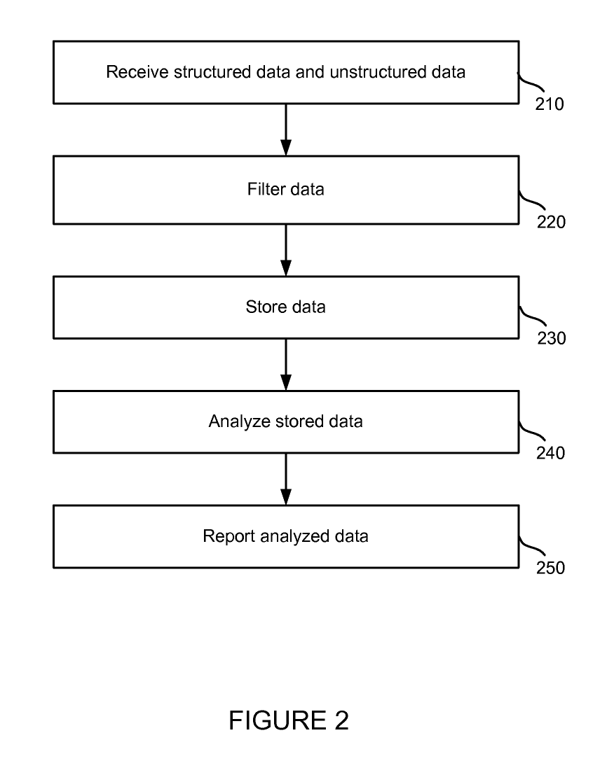

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

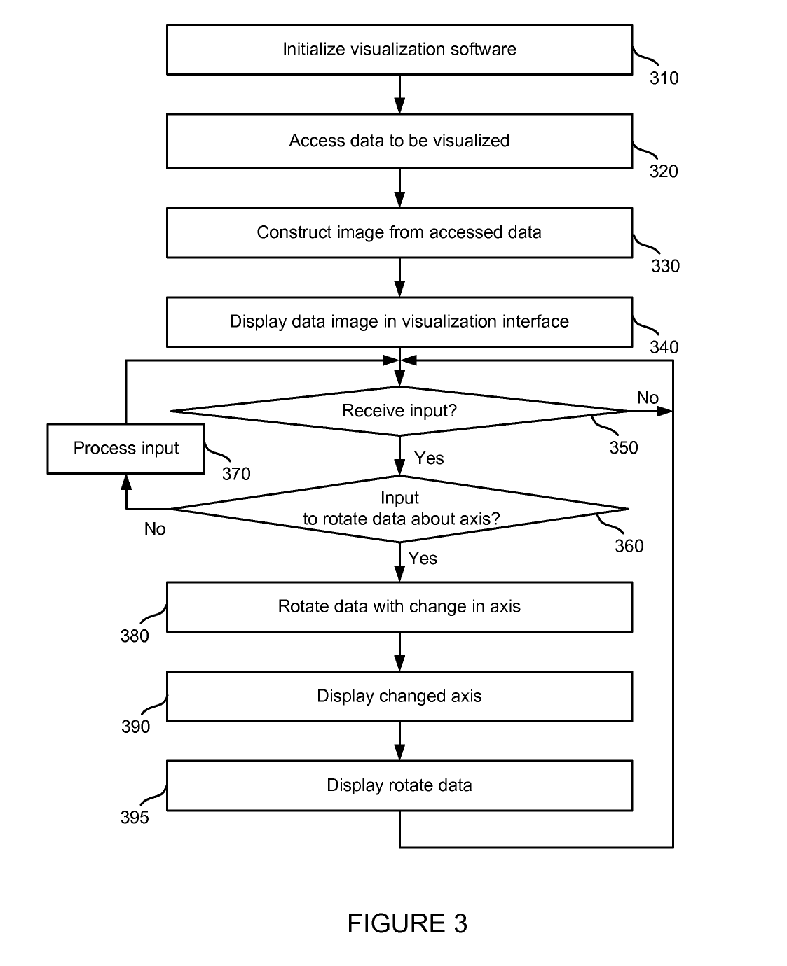

Filtered data may be stored at step 230. The data may be stored based on the type of data it is. For example, structured data may be stored in a SQL database and unstructured data may be stored in a NoSQL database. The stored data may be analyzed at step 240. Analyzing the data may include looking for trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a three dimensional graph of data and allow a user to manipulate the location of data about an axis. Step 250 is discussed in more detail with respect to FIG. 3.

FIG. 3 is a method for providing a visualization of data. The method of FIG. 3 may provide more detail for step 250 of the method of FIG. 2. In embodiments, visualization application 162 may perform the steps of FIG. 3. The visualization application 162 may extract stored data, mine data for desired information, and provide an interactive visualization of the data.

First, visualization software is initialized at step 310. Initializing the data may include executing the software, identifying what data to retrieve, and other configurations of the software. Data to be visualized may be accessed at step 320. The data may be accessed locally or remotely, for example from data store 140. An image from the accessed data is then constructed for display at step 330. The image for display may for example be constructed in a three dimensional scatter plot, having an x, y and z axis, or some other format.

The data image is displayed in a visualization interface at step 340. In some embodiments, a visualization interface may include a graphics portion and a control portion. The graphics portion may include the data displayed within a coordinate system. A control portion may include one or more interface buttons and other selectable objects for controlling and configuring the display in the graphical portion. The control portion may be implemented on a separate page or window than the graphical portion, or may otherwise be implemented separately from the graphical portion.

A determination is made as to whether input is received at step 350. If input is not received, the method of FIG. 3 remains at step 315 until input is received. Once input is received, a determination is made as to whether the input is a request to rotate data about a particular axis within a graphical portion of an interface at step 360. In some embodiments, the input to rotate data about a particular axis may comprise of a selection of a particular axis. The input may be a continuous input that includes manipulating a cursor over the particular axis. The input may be received within a graphical portion of a visualization interface, thereby avoiding requiring a user to navigate to a different portion of the interface, or different interface page, to provide input to manipulate the visualization.

The input to rotate data about a particular axis may be associated with an axis of one of more axes implemented in the graphical portion of the interface. For example, a user may drag a cursor using a peripheral device, such as a computer mouse, over an x axis in an x,y,z axis system while depressing a mouse button. The received input may result in moving the position of the data about the axis by a rotation indicated by the input. For example, moving a cursor from one side of the axis to the axis itself may result in a ninety degree rotation. Moving an axis from one position on one side of the axis to another position on the other side of the axis, where both positions are about the same distance away from the axis, may automatically result in rotating the data one hundred and eight degrees. Although selection of a coordinate axis resulting in making data move about the axis is discussed in the method of FIG. 3, different movements of the data in response to selection of the axis in the graphical portion of an interface are within the scope of the present invention.

If the input is to designate the selected axis as the vertical axis at step 360, data is rotated based on the changed axis at step 380. Rotation of the data may include determining how the data should be displayed in the graphical portion of the interface based on the change in axis orientation. The rotation may be performed continuously as the cursor is continuously dragged about an axis. The changed axis locations are provided in the interface at step 390. The axes positions may be updated as the data is rotated. The rotated data is then displayed in the interface at step 395. The method of FIG. 3 then returns to step 350. If no input is received at step 360, the input received as process is normal at step 370 and the method of FIG. 3 returns to step 350.

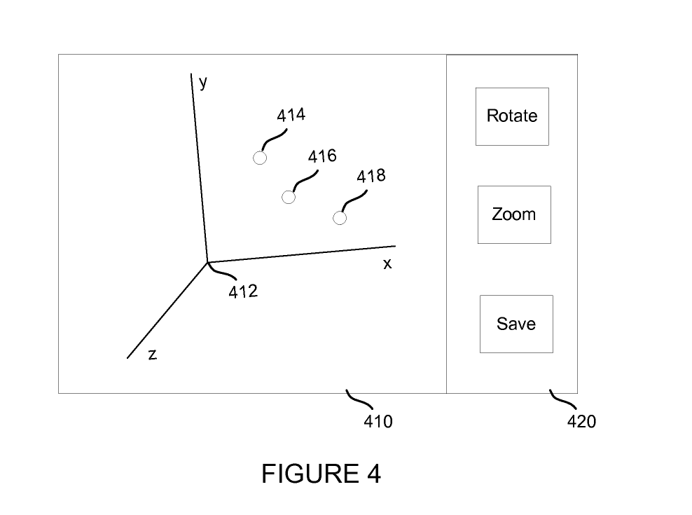

FIGS. 4-6 illustrate examples of a visualization interface for displaying three dimensional data. FIG. 4 provides a visualization interface 400. The visualization interface of FIG. 4 provides a graphics portion 410 and a control portion 420. The control portion 420 includes buttons for performing functions, such as for example a rotate button, zoom button and save button. In some embodiments, control portion may be implemented on a separate interface page than graphics portion 410. Graphics portion 410 includes a graphical coordinate system, such as x, y, z axes 412, and data such as data points 414, 416 and 418. In the interface of FIG. 4, the control of data manipulation within the graphics portion is managed by an interface within the control portion and separate from the graphics portion.

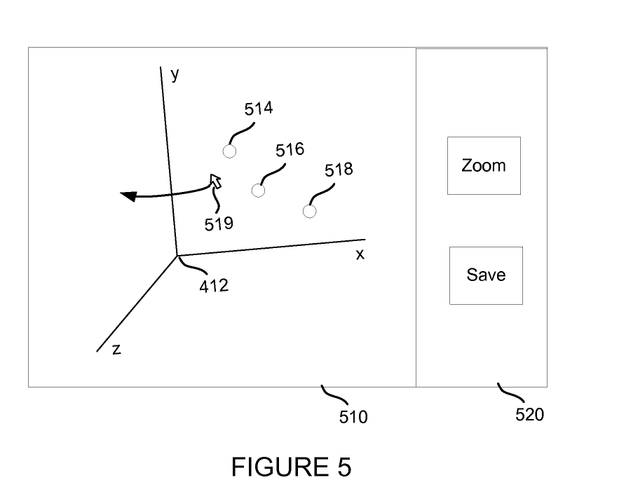

FIG. 5 is another example of a visualization interface. The interface of FIG. 5 includes an interface for providing input within a graphics portion of the visualization interface to manipulate data about an axis. Within the graphics portion 510, a cursor 519 may be used to continuously select a space about the x axis. An example of a continuous selection may be drag across an axis, or other input that covers more than a single point in the display. The selection may be made with other input devices as well, and does not in fact have to be continuous. For example, a user may simply select two points along which the data should be rotated.

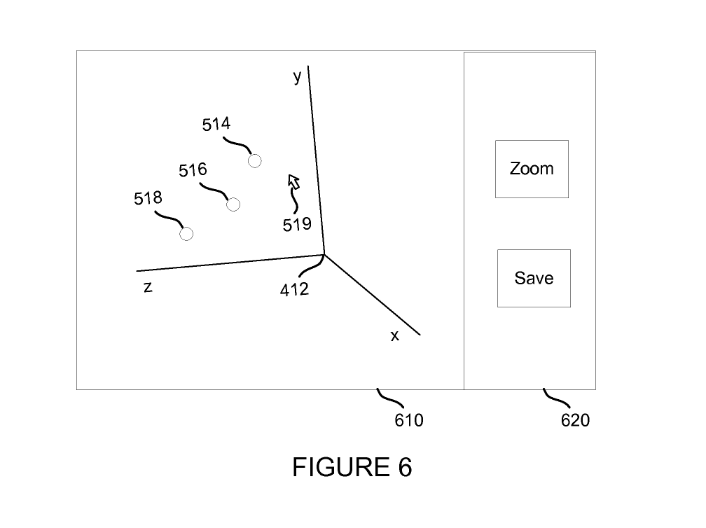

FIG. 6 illustrates a visualization interface having data rotated about an axis. As shown in FIG. 6, the data has been rotated around the x axis which was subject to the continuous input in the graphical portion 510 of FIG. 5. The data points 514-518 have been rotated to have different positions in view of their rotation about the axis.

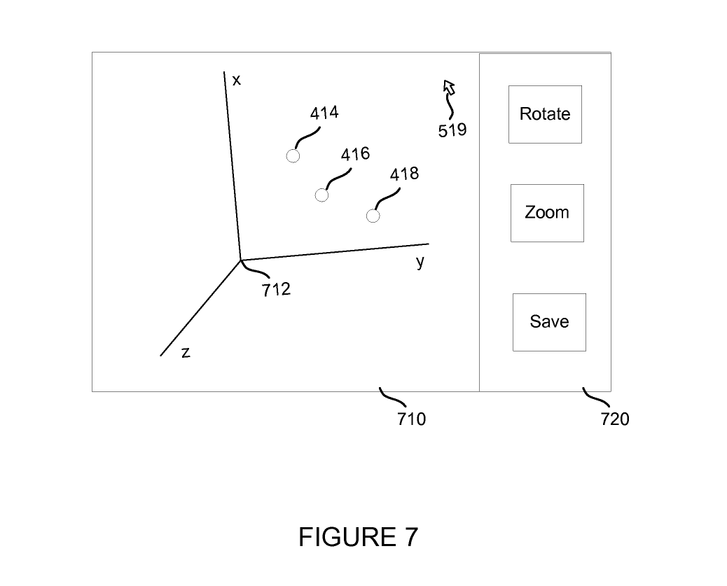

FIGS. 7-9 illustrate examples of a visualization interface for displaying three dimensional data. FIG. 7 provides a visualization interface 700. The visualization interface of FIG. 7 provides a graphics portion 710 and a control portion 720. The control portion 720 includes buttons for performing functions, such as for example a rotate button, zoom button and save button. In some embodiments, control portion may be implemented on a separate interface page than graphics portion 710. Graphics portion 710 includes a graphical coordinate system, such as x, y, z axes 712, and data such as data points 414, 416 and 418. In the interface of FIG. 7 the control of data manipulation within the graphics portion is managed by an interface within the control portion and separate from the graphics portion.

For example, a user may manipulate cursor 519 by providing input to move the cursor from the right to the left in a horizontal motion within a portion of the graphics portion 710. As a result of the input horizontal input, the data 414-418 and axis 712 may rotate about a particular axis, such as an axis 820 aligned vertically with the screen rather than data axis 712.

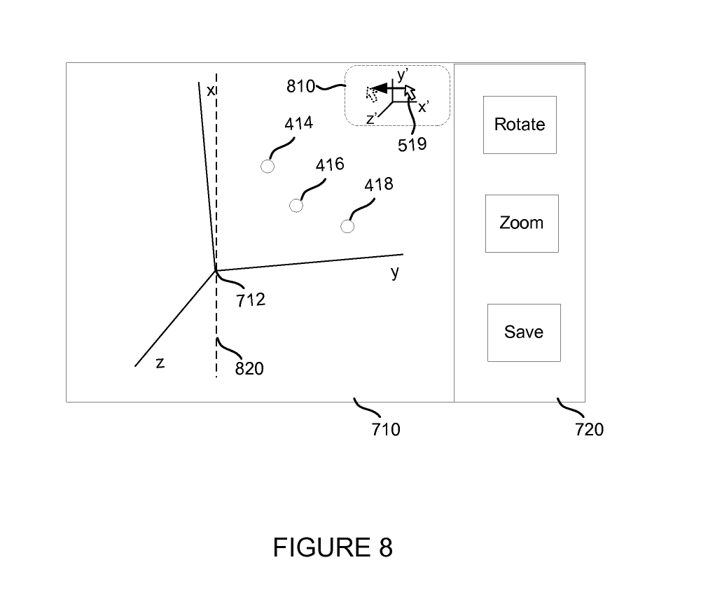

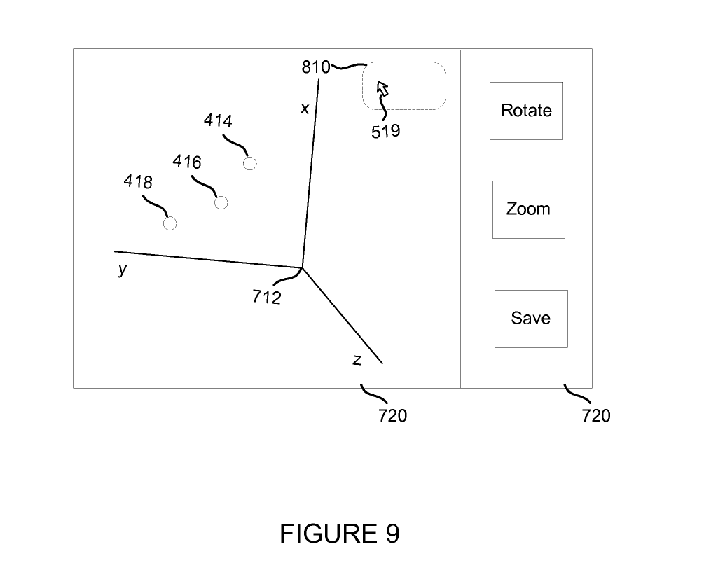

FIG. 8 is another example of a visualization interface. FIG. 8 illustrates the same graphics portion 710 and control portion 720. An axis rotation window 810 is displayed within the graphics portion 710. Window 810 may include a coordinate axis. When a cursor is placed in the axis rotation window and the cursor is moved from the right to the left (for example, moving the cursor with a right button clicked) or other direction about the coordinate axis within window 810, the data 414-418 and axis 712 may rotate about axis 820 rather than data axis 712. FIG. 9 is another visualization interface having data rotated about a display axis. FIG. 9 illustrates the data 414-418 and axis 712 as they may appear after rotation about axis 820—after the cursor input has been received in window 810.

The present technology may also use other centers of rotation that are specified within the window 810. For example, FIG. 8 shows the vertical axis going through the center of the data axes. For rotation in “screen space”, for example, it might be more useful to have the vertical axis go through the center of the screen rather than the center of data axis. In this case, axis 820 would appear to the right of where it is illustrated in FIG. 8, for example approximately where data point 414 is. In another instances, the alternate center of rotation may be set to be through the middle (average or centroid) of either all the data, or of just a subset of the data selected via a filter.

Though rotation about a vertical axis within the interface was discussed with respect to FIGS. 7-9, other rotations may be implemented as well. For example, if cursor 519 was moved from the top to the bottom of rotation window 810, the data 414-418 and axis 712 may rotate towards the screen about a horizontal axis perpendicular to axis 820. Similarly, the input to rotate about an axis may be provided in other ways than moving a cursor and in different locations of the interface.

The present technology may be used to rotate graphically displayed data about coordinate frame axis alignments that are aligned with the data axes and aligned with the screen axes. For either of the two axis alignments, the center of rotation could be in any of several different locations, such as zero point (origin) for the data axis, center of the screen, average point of the all data, and the average point of a subset of data, selected for example via filtering.

In embodiments, the user may toggle which set of axes appear in the window 810 within a graphical portion of the interface. The default could be as described above with respect to FIG. 8, while another other option may be to show an alternate set of axes in the side window (for example, going through the centroid), and to overlay the screen coordinate axes in the main display so the user could rotate about them within the main data display. To minimize clutter, the screen coordinate axes may be shown only when the user's cursor is over them. Rotation about a different set of data axes could then be done in the side window.

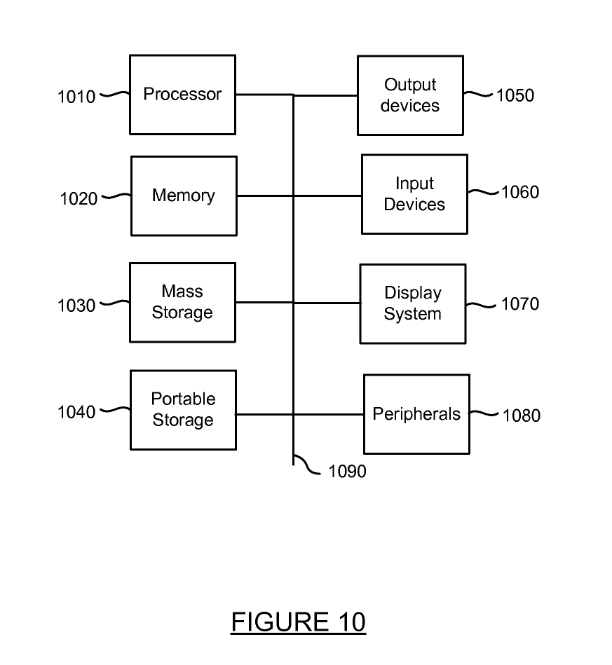

FIG. 10 provides a computing device for implementing the present technology. Computing device 1000 may be used to implement devices such as for example application servers 130, 150 and 160 and data stores 140. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a track ball, stylus, or cursor direction keys. Additionally, the system 1000 as shown in FIG. 10 includes output devices 1050. Examples of suitable output devices include speakers, printers, network interfaces, and monitors.

Display system 70 may include a liquid crystal display (LCD) or other suitable display device. Display system 1070 receives textual and graphical information, and processes the information for output to the display device.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for displaying data, comprising:
providing a three dimensional image of a set of data and one or more axis within a graphical portion of an interface provided by a computing device;
receiving a selection associated with an axis within the graphical portion of the interface; and
modifying the image of the data based on the selection.

2. The method of claim 1, wherein the selection is received as input to move a cursor across a portion of the graphical portion of the interface.

3. The method of claim 1, wherein the image is changed to display the set of data rotating about the axis associated with the continuous movement.

4. The method of claim 1, wherein the axis is a coordinate axis.

5. The method of claim 1, further comprising:
rotating data based on the selection; and
displaying rotated data in response to the selection.

6. The method of claim 1, wherein the one or more axis form an x,y,z coordinate system.

7. The method of claim 1, wherein the interface may include a control portion, the control portion including selectable buttons for controlling display of the image.

8. The method of claim 1, wherein the axis is a data axis.

9. The method of claim 1, wherein the axis is associated with the interface.

10. The method of claim 1, wherein the image of the data is rotated about the data axis.

11. The method of claim 1, wherein the image of the data is rotated about an axis other than the data axis.

12. The method of claim 1, wherein the input is received through a rotation window within a graphical portion of the interface.

13. The method of claim 1, wherein the input includes dragging a cursor through the rotation window in a first direction, the data and the data axis rotated about an axis in the first direction.

14. A computer readable storage medium having embodied thereon a program, the program being executable by a processor to perform a method for displaying data, the method comprising:
providing a three dimensional image of a set of data and one or more axis within a graphical portion of an interface;
receiving a continuous selection associated with an axis within the graphical portion of the interface; and
modifying the image of the analyzed data based on the selection.

15. The computer readable storage medium of claim 8, wherein the selection is received as input to move a cursor across a portion of the graphical portion of the interface.

16. The computer readable storage medium of claim 8, wherein the image is changed to display the set of data rotating about the axis associated with the continuous movement.

17. The computer readable storage medium of claim 8, wherein the axis is a coordinate axis.

18. The computer readable storage medium of claim 8, further comprising:
rotating data based on the selection; and
displaying rotated data in response to the selection.

19. The computer readable storage medium of claim 8, wherein the one or more axis form an x,y,z coordinate system.

20. The computer readable storage medium of claim 14, wherein the axis is a data axis.

21. The computer readable storage medium of claim 14, wherein the axis is associated with the interface.

22. The computer readable storage medium of claim 14, wherein the image of the data is rotated about the data axis.

23. The computer readable storage medium of claim 14, wherein the image of the data is rotated about an axis other than the data axis.

24. The computer readable storage medium of claim 14, wherein the input is received through a rotation window within a graphical portion of the interface.

25. The computer readable storage medium of claim 14, wherein the input includes dragging a cursor through the rotation window in a first direction, the data and the data axis rotated about an axis in the first direction.

26. A system for displaying data, comprising:
a processor;
memory;
one or more modules stored in memory and executed by the processor to provide a three dimensional image of a set of data and one or more axis within a graphical portion of an interface, receive a continuous selection associated with an axis within the graphical portion of the interface, and modify the image of the analyzed data based on the selection.

27. The system of claim 14, wherein the selection is received as input to move a cursor across a portion of the graphical portion of the interface.

28. The system of claim 14, wherein the image is changed to display the set of data rotating about the axis associated with the continuous movement.

29. The system of claim 14, wherein the axis is a coordinate axis.

30. The system of claim 14, the one or more modules executable to rotate data based on the selection and display rotated data in response to the selection.

31. The system of claim 14, wherein the one or more axis form an x,y,z coordinate system.

32. The system of claim 14, wherein the interface includes a control portion, the control portion including selectable buttons for controlling display of the image.

33. The system of claim 1, wherein the axis is a data axis.

34. The system of claim 1, wherein the axis is associated with the interface.

35. The system of claim 1, wherein the image of the data is rotated about the data axis.

36. The system of claim 1, wherein the image of the data is rotated about an axis other than the data axis.

37. The system of claim 1, wherein the input is received through a rotation window within a graphical portion of the interface.

38. The system of claim 1, wherein the input includes dragging a cursor through the rotation window in a first direction, the data and the data axis rotated about an axis in the first direction.
